(19) United States
(12) Patent Application Publication
(10) Pub. No.: US 2011/0320183 A1
(43) Pub. Date: Dec. 29, 2011

(54) COMPUTING DEVICE AND METHOD FOR ANALYZING DIFFERENTIAL TRANSMISSION LINES PORT RELATIONSHIPS

(75) Inventors: PO-CHUAN HSIEH, Tu-Cheng (TW); YU-CHANG PAI, Tu-Cheng (TW); CHIEN-HUNG LIU, Tu-Cheng (TW)

(73) Assignee: HON HAI PRECISION INDUSTRY CO., LTD., Tu-Cheng (TW)

(21) Appl. No.: 12/906,126

(22) Filed: Oct. 17, 2010

(30) Foreign Application Priority Data
Jun. 24, 2010 (TW) 99120714

(51) Int. Cl. G06F 17/50

(52) U.S. Cl. 703/14

(57) ABSTRACT

A computing device and a method determines port relationships of a differential transmission line of a circuit board according to an original scattering parameters file, which records scattering parameter values measured from ports of the differential transmission line under different signal frequencies. The computing device generates a new scattering parameters file matching a scattering parameters model predefined for the differential transmission line according to the determined port relationships. Design of the differential transmission line is analyzed to determine if the differential transmission line is qualified according to the new scattering parameters file and the scattering parameters model.

### BACKGROUND

1. Technical Field

Embodiments of the present disclosure relates to circuit simulating methods, and more particularly, to a computing device and a method for analyzing differential transmission lines port relationships of a circuit board.

2. Description of Related Art

Compared with single-ended signaling, differential signaling is more less prone to resistance interference and noise. Differential signaling is a method for sending two complementary signals on a pair of differential ports of a differential transmission line. For example, as shown in FIG. 4, a four-port transmission line consists of a first wire L1 and a second wire L2. The first wire L1 has a port 1 and a port 3, and the second wire L2 has a port 2 and a port 4. Then, port 1 and port 2 are regarded as a pair of differential ports, and port 3 and port 4 are regarded as another pair of differential ports, and the differential signaling may send two complementary signals, such as “1010” and “0101” to port 1 and port 2 at the same time.

Scattering parameters (S-parameters) are a useful method for analyzing external behavior of a circuit design without any regard for the content of the circuit. Often, an engineer may implement the S-parameters measured from differential ports of the circuit under different frequencies into a predetermined S-parameters model, to analyze if the circuit design is qualified. One problem is that, the predetermined S-parameters model may be created according to one kind of differential port relationships (such as shown in FIG. 5), however, the measured S-parameters may come from another kind of differential port relationships (such as shown in FIG. 4). As a result, the analysis result of the circuit design may be wrong due to the fact that the measured S-parameters do not match the S-parameters model.

### BRIEF DESCRIPTION OF THE DRAWINGS

FIG. 1 is a block diagram of one embodiment of a computing device for analyzing port relationships of differential transmission lines in a circuit board.

FIG. 2 is a block diagram of one embodiment of function modules of an analysis unit in the computing device of FIG. 1.

FIG. 3 is a flowchart of one embodiment of a method for analyzing port relationships of differential transmission lines in a circuit board.

FIG. 4 and FIG. 5 are one embodiment of two four-port differential transmission lines with different kinds of port relationships.

### DETAILED DESCRIPTION

The disclosure, including the accompanying drawings in which like references indicate similar elements, is illustrated by way of examples and not by way of limitation. It should be noted that references to “an” or “one” embodiment in this disclosure are not necessarily to the same embodiment, and such references mean at least one.

In general, the word “module,” as used hereinafter, refers to logic embodied in hardware or firmware, or to a collection of software instructions, written in a programming language, such as, for example, Java, C, or Assembly. One or more software instructions in the modules may be embedded in firmware. It will be appreciated that modules may comprised connected logic units, such as gates and flip-flops, and may comprise programmable units, such as programmable gate arrays or processors. The modules described herein may be implemented as either software and/or hardware modules and may be stored in any type of computer-readable medium or other computer storage device.

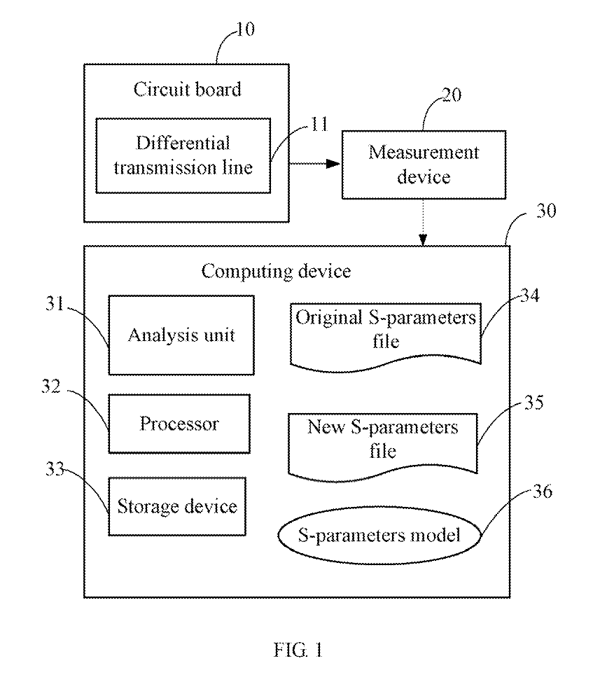

FIG. 1 is a block diagram of one embodiment of a computing device 30. The computing device 30 can analyze port relationships of a differential transmission line 11 of a circuit board 10. The computing device 30 is connected to a measurement device 20. The measurement device 20 measures signals transmitted on the differential transmission line 11, to obtain an original scattering parameters (S-parameters) file 34, and stores the original S-parameters file 34 in a storage device 33 of the computing device 30. Depending on the embodiment, the storage device 33 may be a smart media card, a secure digital card, or a compact flash card. The measurement device 20 may be a network analyzer. The computing device 30 may be a personal computer, or a server, for example.

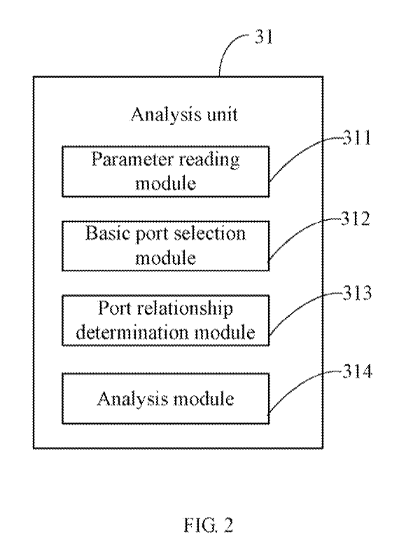

In this embodiment, the computing device 30 further includes an analysis unit 31 and a processor 32. The analysis unit 31 includes a number of function modules (detailed description is given in FIG. 2) The function modules may comprise computerized code in the form of one or more programs that are stored in the storage device 33. The computerized code includes instructions that are executed by the at least one processor 32, to determine port relationships of the differential transmission line 11 according to the original S-parameters file 34, generate a new S-parameters file 35 matching a S-parameters model 36 predefined for the differential transmission line 11 according to the determined port relationships, and analyze if a design of the differential transmission line 11 is qualified according to the new S-parameters file 35 and the S-parameters model 36.

FIG. 2 is a block diagram of the function modules of the analysis unit 31 in the computing device of FIG. 1. The analysis unit 31 includes a parameter reading module 311, a basic port selection module 312, a port relationship determination module 313, and an analysis module 314.

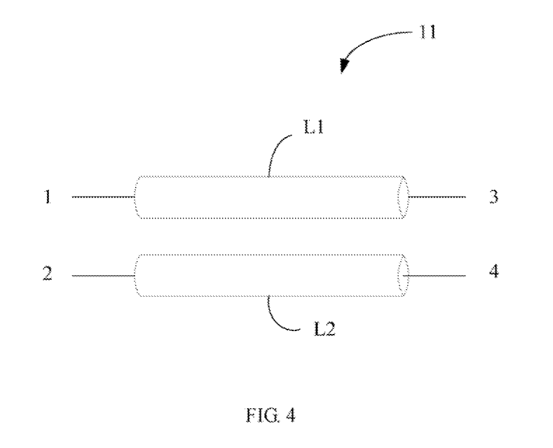

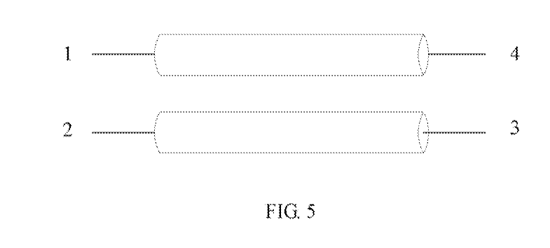

The parameter reading module 311 reads the original S-parameters file 34 from the storage device 33. In one embodiment, the S-parameters include reflection coefficients, insertion loss coefficients, near-end crosstalk coefficients, and remote-end crosstalk coefficients of each port of the differential transmission line 11. The original S-parameters file 34 records S-parameter values measured from ports of the differential transmission line 11 under different signal frequencies. For example, supposing the differential transmission line 11 includes four ports numbered 1, 2, 3, and 4 as shown in FIG. 4 or FIG. 5. When a test signal is input to the port 1, the port 1 will receive a reflection signal, and the port 2, 3, 4 will respectively receive a first, second, and third transmission signal. Then, a ratio of the reflection signal power and the test signal power is regarded as a reflection coefficient S11, a ratio of the second transmission signal power and the test signal power is regarded as an insertion loss coefficient S12, a ratio of the third transmission signal power and the test signal power is regarded as a near-end crosstalk coefficient S13, and a ratio of the third transmission signal power and the test signal power is regarded as a remote-end crosstalk coefficient S14. When a frequency of the test signal changes, values of the ratios changes, so the original S-parameters file 34 records a large quantity of S-parameter values.

The basic port selection module 312 selects a port as a basic port from the ports of the differential transmission line 11. For example, port 1 may be selected as a basic port.

The parameter reading module 311 reads S-parameter values of remaining ports associated with the basic port from the original S-parameters file 34. For example, the values of the coefficients S12, S13, and S14 under different signal frequencies are read.

The port relationship determination module 313 selects a maximum S-parameter value on condition that a signal with a lowest frequency is input to the basic port (e.g., port 1), and determines a port directly connected with the basic port according to the maximum value. It is understood that, when the signal with the lowest frequency (such as 30 KHz) is input to the basic port (e.g., port 1), only the port (e.g., port 3) directly connected with the basic port (e.g., port 1) is enabled to make contact with the basic port (e.g., port 1). Taking FIG. 4 as an example, if the signal with the lowest frequency (such as 30 KHz) is input to port 1, the signal can only reach port 3, so compared with S12 and S14, S13 has a maximum value.

The port relationship determination module 313 selects a minimum S-parameter value on condition that the signal with a highest frequency is input to the basic port, determines a port farthest to the basic port according to the minimum S-parameter value. It is understood that, when the signal with the highest frequency (such as 20 GHz) is input to the basic port (e.g., port 1), all ports (e.g., port 2, port 3, and port 4) are enabled to make contact with the basic port (e.g., port 1), however, the farther the signal passes through, the more power the signal losses. Taking FIG. 4 as an example, if the signal with the highest frequency (such as 20 GHz) is input to port 1, the signal can reach port 2, port 3, and port 4. Since port 4 is farthest to port 1, a signal received by port 4 has a lower power compared to signals received by port 3 and port 2. Therefore, compared to S12 and S13, S14 has a minimum value.

In addition, the port relationship determination module 313 determines a port nearest to the basic port according to remaining S-parameter values. Since the port (e.g., port 3) directly connected with the basic port and the port (e.g., port 4) farthest to the basic port have been determined, then the remaining port (e.g., port 2) is determined as the port nearest to the basic port.

Moreover, the port relationship determination module 313 generates a new S-parameters file 35 according to determined relationships among the ports of the differential transmission line 11, so that the new S-parameters file 35 matches the S-parameters model 36. For example, if the S-parameters model 36 is established based on the port relationships shown in FIG. 5, then the port relationship determination module 313 exchanges the port numbers 3 and 4 in the original S-parameters file 34 to obtain the new S-parameters file 35, so that the port relationships in the new S-parameters file 35 are consistent with port relationships in the S-parameters model 36.

The analysis module 314 analyzes if the design of the design of the differential transmission line 11 is qualified according to the new S-parameters file 35 and the S-parameters model 36. For example, the analysis module 314 implements the new S-parameters file 35 in the S-parameters model 36, obtains one or more analysis results, and compares the one or more analysis results with predetermined standards, to determine if the design (such as sizes, spaces of the two wires L1 and L2) of the differential transmission line 11 is qualified.

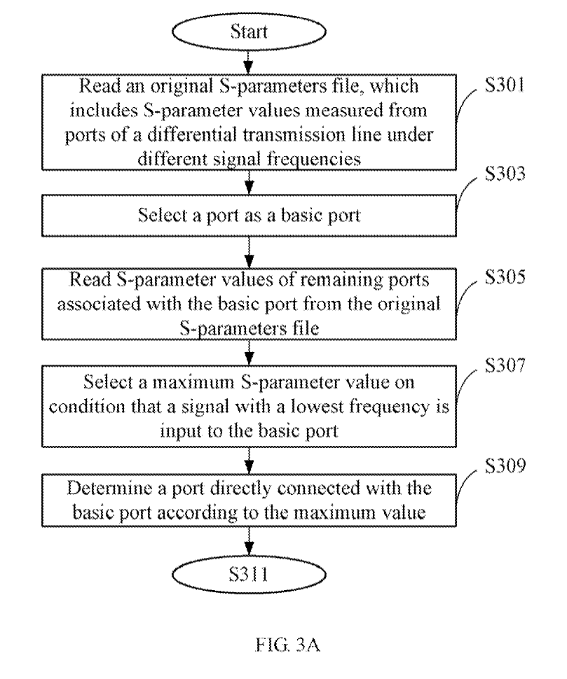

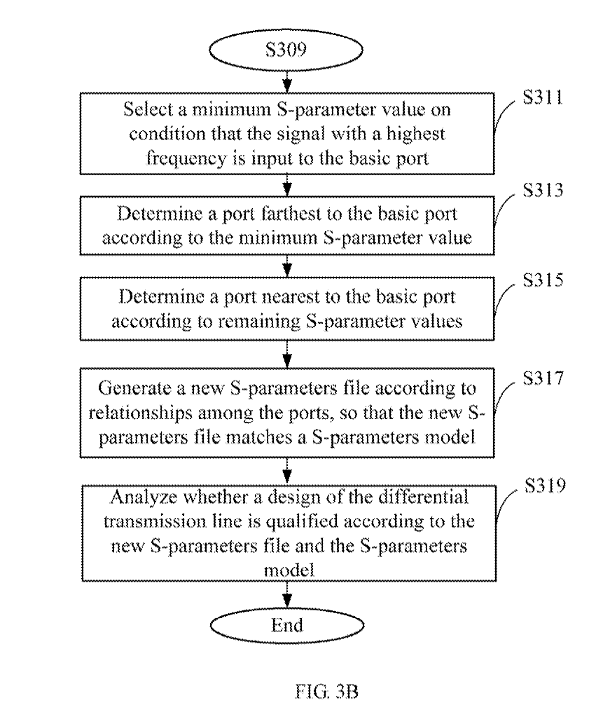

FIG. 3 is a flowchart of one embodiment of a method for analyzing port relationships of differential transmission lines in a circuit board. Depending on the embodiment, additional blocks may be added, others removed, and the ordering of the blocks may be changed.

In block S301, the parameter reading module 311 reads the original S-parameters file 34 from the storage device 33. As mentioned above, the S-parameters include reflection coefficients, insertion loss coefficients, near-end crosstalk coefficients, and remote-end crosstalk coefficients of each port of the differential transmission line 11. For example, supposing the differential transmission line 11 includes four ports numbered 1, 2, 3, and 4 as shown in FIG. 4, then the S-parameters include a reflection coefficient S11, an insertion loss coefficient S12, a near-end crosstalk coefficient S13, and a remote-end crosstalk coefficient S14. The original S-parameters file 34 records S-parameter values measured from ports of the differential transmission line 11 under different signal frequencies, such as values of S11, S12, S13, and S14 measured under different signal frequencies.

In block S303, the basic port selection module 312 selects a port as a basic port from the ports of the differential transmission line 11. For example, the basic port selection module 312 may select port 1 as a basic port.

In block S305, the parameter reading module 311 reads S-parameter values of remaining ports associated with the basic port from the original S-parameters file 34. For example, the values of the coefficients S12, S13, and S14 under different signal frequencies are read.

In block S307, the port relationship determination module 313 selects a maximum S-parameter value on condition that a signal with a lowest frequency is input to the basic port (e.g., port 1). As mentioned above, when the signal with the lowest frequency (such as 30 KHz) is input to the basic port (e.g., port 1), only the port (e.g., port 3) directly connected with the basic port (e.g., port 1) is enabled to make contact with the basic port (e.g., port 1). Taking FIG. 4 as an example, if the signal with the lowest frequency (such as 30 KHz) is input to port 1, the signal can only reach port 3, so compared with S12 and S14, S13 has a maximum value.

In block S309, the port relationship determination module 313 determines a port directly connected with the basic port according to the maximum value. For example, if the S13 has the maximum value on condition that the signal with the lowest frequency of 30 KHz is input to port 1, port 3 is determined as the port directly connected with port 1.

In block S311, the port relationship determination module 313 selects a minimum S-parameter value on condition that the signal with a highest frequency is input to the basic port. As mentioned above, when the signal with the highest frequency (such as 20 GHz) is input to the basic port (e.g., port 1), all ports (e.g., port 2, port 3, and port 4) are enabled to make contact with the basic port (e.g., port 1), however, the farther the signal passes through, the more power the signal losses. Taking FIG. 4 as an example, the signal with the highest frequency (such as 20 GHz) is input to port 1, the signal can reach port 2, port 3, and port 4. Since port 4 is farthest to port 1, a signal received by port 4 has a lower power compared to signals received by port 3 and port 2. Therefore, compared to S12 and S13, S14 has a minimum value.

In block S313, the port relationship determination module 313 determines a port farthest to the basic port according to the minimum S-parameter value. For example, if S14 has the minimum value on condition that the signal with the highest frequency 20 GHz is input to port 1, port 4 is determined as the port farthest to port 1.

In block S315, the port relationship determination module 313 determines a port nearest to the basic port according to remaining S-parameters. For example, as mentioned above, port 3 is determined as the port directly connected with port 1, then the rest port 2 is determined as the port nearest to port 1.

In block S317, the port relationship determination module 313 generates a new S-parameters file 35 according to determined relationships among the ports of the differential transmission line 11, so that the new S-parameters file 35 matches the S-parameters model 36. For example, as mentioned above, if the S-parameters model 36 is established based on the port relationships shown in FIG. 5, then the port relationship determination module 313 exchanges the port numbers 3 and 4 in the original S-parameters file 34 to obtain the new S-parameters file 35, so that the port relationships in the new S-parameters file 35 are consistent with port relationships in the S-parameters model 36.

In block S319, the analysis module 314 analyzes if the design of the design of the differential transmission line 11 is qualified according to the new S-parameters file 35 and the S-parameters model 36. For example, the analysis module 314 implements the new S-parameters file 35 in the S-parameters model 36, obtains one or more analysis results, and compares the one or more analysis results with predetermined standards, to determine if the design, such as sizes, spaces of the two wires L1 and L2 of the differential transmission line 11 shown in FIG. 4 is qualified.

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. A computing device, comprising:
a storage device;
at least one processor; and
an analysis unit comprising one or more computerized codes, which are stored in the storage device and executable by the at least one processor, the one or more computerized codes comprising:
a parameter reading module operable to read an original scattering parameters file from the storage device, wherein the original scattering parameters file records scattering parameter values measured from ports of a differential transmission line of a circuit board under different signal frequencies;
a basic port selection module operable to select a port as a basic port from the ports of the differential transmission line;
the parameter reading module further operable to read scattering parameter values of remaining ports associated with the basic port from the original scattering parameters file; and
a port relationship determination module operable to select a maximum scattering parameter value on condition that a signal with a lowest frequency is input to the basic port, determine a port directly connected with the basic port according to the maximum scattering parameter value, select a minimum scattering parameter value on condition that the signal with a highest frequency is input to the basic port, determine a port farthest to the basic port according to the minimum scattering parameter value, and determine a port nearest to the basic port according to remaining scattering parameter values.

2. The computing device as claimed in claim 1, wherein the port relationship determination module is further operable to generate a new scattering parameters file according to determined relationships among the ports of the differential transmission line, so that the new scattering parameters file matches a scattering parameters model predefined for the differential transmission line.

3. The computing device as claimed in claim 2, wherein the one or more computerized codes further comprise an analysis module operable to analyze if a design of the differential transmission line is qualified according to the new scattering parameters file and the scattering parameters model.

4. The computing device as claimed in claim 1, wherein the scattering parameters comprise reflection coefficients, insertion loss coefficients, near-end crosstalk coefficients, and remote-end crosstalk coefficients of each port of the differential transmission line.

5. The computing device as claimed in claim 1, wherein the storage device is selected from the group consisting of a smart media card, a secure digital card, and a compact flash card.

6. A computer-based method for analyzing port relationships of differential transmission lines of a circuit board, the method comprising:
reading an original scattering parameters file from a storage device of a computing device, wherein the original scattering parameters file records scattering parameter values measured from ports of a differential transmission line of the circuit board under different signal frequencies;
selecting a port as a basic port from the ports of the differential transmission line;
reading scattering parameter values of remaining ports associated with the basic port from the original scattering parameters file;
selecting a maximum scattering parameter value on condition that a signal with a lowest frequency is input to the basic port, and determining a port directly connected with the basic port according to the maximum scattering parameter value;
selecting a minimum scattering parameter value on condition that a signal with a highest frequency is input to the basic port, and determining a port farthest to the basic port according to the minimum scattering parameter value; and
determining a port nearest to the basic port according to remaining scattering parameter values.

7. The method as claimed in claim 6, further comprising:
generating a new scattering parameters file according to the determined relationships among the ports of the differential transmission line, so that the new scattering parameters file matches a scattering parameters model predefined for the differential transmission line.

8. The method as claimed in claim 7, further comprising:
analyzing if a design of the differential transmission line is qualified according to the new scattering parameters file and the scattering parameters model.

9. The method as claimed in claim 7, wherein the scattering parameters model is also stored in the storage device of the computing device.

10. The method as claimed in claim 6, wherein the storage device is selected from the group consisting of a smart media card, a secure digital card, and a compact flash card.

11. The method as claimed in claim 6, wherein the scattering parameters comprise reflection coefficients, insertion loss coefficients, near-end crosstalk coefficients, and remote-end crosstalk coefficients of each port of the differential transmission line.

12. A non-transitory computer readable medium storing a set of instructions, the set of instructions capable of being executed by a processor of a computing device to perform a method for analyzing port relationships of differential transmission lines of a circuit board, the method comprising:
reading an original scattering parameters file from the non-transitory computer readable medium, wherein the original scattering parameters file records scattering parameter values measured from ports of a differential transmission line of the circuit board under different signal frequencies;
selecting a port as a basic port from the ports of the differential transmission line;
reading scattering parameter values of remaining ports associated with the basic port from the original scattering parameters file;
selecting a maximum scattering parameter value on condition that a signal with a lowest frequency is input to the basic port, and determining a port directly connected with the basic port according to the maximum value;
selecting a minimum scattering parameter value on condition that the signal with a highest frequency is input to the basic port, and determining a port farthest to the basic port according to the minimum scattering parameter value; and
determining a port nearest to the basic port according to remaining scattering parameter values.

13. The medium as claimed in claim 12, wherein the method further comprises:
generating a new scattering parameters file according to determined relationships among the ports of the differential transmission line, so that the new scattering parameters file matches a scattering parameters model predefined for the differential transmission line.

14. The medium as claimed in claim 13, wherein the method further comprises:
analyzing if a design of the differential transmission line is qualified according to the new scattering parameters file and the scattering parameters model.

15. The medium as claimed in claim 12, wherein the medium is selected from the group consisting of a smart media card, a secure digital card, and a compact flash card.
